(19) United States
(12) Patent Application Publication
(10) Pub. No.: US 2011/0035318 A1
(43) Pub. Date: Feb. 10, 2011

(54) CREDIT AND DEBIT CARD TRANSACTION APPROVAL USING LOCATION VERIFICATION

(75) Inventors: Mark A. Hargrove, Laurys Station, PA (US); James A. Johanson, Schwenksville, PA (US); Stanley Reinhold, Allentown, PA (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 12/296,433

(22) PCT Filed: Dec. 28, 2007
(86) PCT No.: PCT/US07/89019

§ 371 Date: Aug. 3, 2010

(51) Int. Cl. G06Q 40/00

(52) U.S. Cl. 705/44

(57) ABSTRACT

In one embodiment, an online credit or debit card transaction is processed by transmitting purchase information, including price of the purchase item and card number, to the company that issued the card. In addition, the location from which the purchase is made is calculated, e.g., using a GPS device, and the location data is transmitted to the card issuer. The card issuer determines if the purchase meets certain specified approval requirements, such as whether the card holder has sufficient funds, the card has been reported missing, or card holder's personal information is correct. Further, the card issuer compares the location data to a number of predetermined purchase locations specified by the customer. If the location data matches one of the predetermined locations and the specified approval requirements are met, then the purchase is approved.

### BACKGROUND OF THE INVENTION

1. Field of the Invention

The present invention relates to online credit and debit card transactions, and, in particular, to securing such transactions to reduce the occurrence of fraud.

2. Description of the Related Art

Generally, there are two categories of credit card (and debit card) transactions: swiped transactions and non-swiped transactions. Swiped transactions require the credit card to be physically present at the merchant's place of business so that the card can be swiped through a card reader. In non-swiped transactions, on the other hand, the credit card does not need to be present to complete a purchase. Non-swiped transactions may be completed in person, over the phone, or through the internet by providing the credit card number to the merchant.

The two categories of transactions create unique opportunities for credit card fraud. For example, commit fraud through swiped transactions, the fraudulent user must physically possess the credit card. One method to guard against fraudulent purchases made through swiped transactions is for the customer to maintain possession of his credit card at all times. If the card should be misplaced, or otherwise removed from the customer's control, then the customer may cancel the credit card through the credit card company or bank that issued the card.

To commit fraud through non-swiped transactions, on the other hand, a fraudulent user needs only the credit card number and not the actual card itself. Access to the credit card number can be gained through any of a number of different methods. For example, a merchant's employee may take note of the credit card number when performing either a swiped or non-swiped transaction, a merchant's records of credit card transactions may be stolen, or websites containing the credit card number may be compromised by internet hackers.

Once a credit card number is out of the card owner's control, the number is free to be passed around or sold on the black market. The fact that the credit card owner may still be in possession of the credit card while a fraudulent user is making purchases, makes fraudulent purchases committed through non-swiped transactions more difficult to detect than those committed through swiped transactions. As a result, fraudulent purchases made through non-swiped transactions often go undetected until a significant amount of harm has been caused.

Reducing credit card fraud through non-swiped transactions may be approached from two general directions. First, measures may be taken to prevent card numbers from being stolen. This approach, however, may be fairly difficult given the number of different methods that may be employed to steal card numbers. Second, measures may be taken to prevent stolen card numbers from being used in non-swiped transactions. For example, in one such method, in addition to the credit card number itself a three- or four-digit security code number on the back of the credit card is required for purchases. While this method might cut down on some fraudulent activity, the opportunities for this security code number to be stolen are almost as prevelant as those for stealing the credit card number itself. In another such method, the credit card owner uses a private pin code in conjunction with the credit card number to make purchases. This method may be more secure than the security code number on the back of the credit card, but there are still opportunities for the pin code to be stolen (e.g., when a merchant has to manually enter the pin code into a credit card terminal). In yet another such method, virtual credit card numbers may be provided by the credit card company for a specified number of purchases. The virtual credit card number continuously changes making the number more difficult to steal, and if the number is stolen, the amount of damage that may occur due to fraudulent purchases is limited to the number of purchases that can be made with the virtual credit card number.

### SUMMARY OF THE INVENTION

In one embodiment, the present invention is a computer-implemented method and apparatus for processing an internet-based purchase request made by a user of a communications device. The apparatus implements the method, which comprises receiving, from the communications device, (1) the purchase request, which includes information about a customer account, and (2) location information corresponding to location of the communications device, which is independently generated by the communications device. The location information is compared to one or more approved locations corresponding to the customer account. If the location information does not match any of the one or more approved locations, then the purchase request is rejected.

According to another embodiment, the present invention is a computer-implemented method and apparatus for making an internet-based purchase request from a user of a communications device. The apparatus implements the method, which comprises transmitting the purchase request to a merchant device via the internet, wherein the purchase request includes information about a customer account issued by a customer account company. The merchant device transmits the customer account information to a customer account company device. Location information corresponding to location of the communications device is independently generated and transmitted to the customer account company device. The customer account company device (i) compares the location information to one or more approved locations corresponding to the customer account and (ii) rejects the purchase request, if the location information does not match any of the one or more approved locations.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of one implementation of an online credit card system;

FIG. 2 is a simplified flow diagram illustrating the steps of a transaction performed using the online credit card system of FIG. 1;

FIG. 3 shows a simplified block diagram of a location verification (LV) credit card system according to one embodiment of the present invention;

FIG. 4 shows a simplified flow diagram illustrating the steps of a transaction performed using the LV credit card system of FIG. 3 according to one embodiment of the present invention;

FIG. 5 shows a simplified block diagram of an LV credit card system according to another embodiment of the present invention; and

FIG. 6 shows a simplified flow diagram illustrating the steps of a transaction performed using the LV credit card system of FIG. 5 according to one embodiment of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention is aimed at reducing the occurrences of credit card and debit card fraud committed through online purchases by reducing the ease with which a stolen card number can be used to make a purchase. In general, the present invention identifies the location from which a purchase is initiated. The location data is independently generated without the use of manual customer input and is transmitted for comparison to one or more predetermined approved locations specified by the customer. If the transmitted location matches one of the predetermined approved locations, the online transaction is approved. Otherwise, the transaction is rejected.

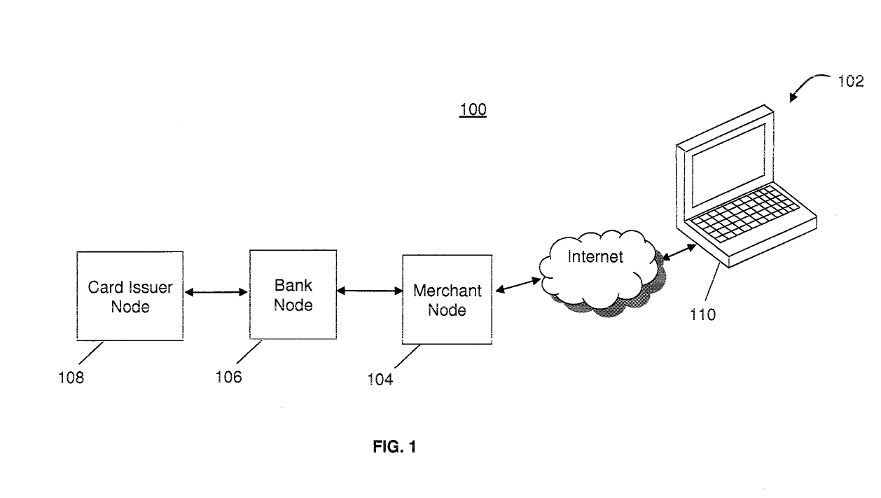

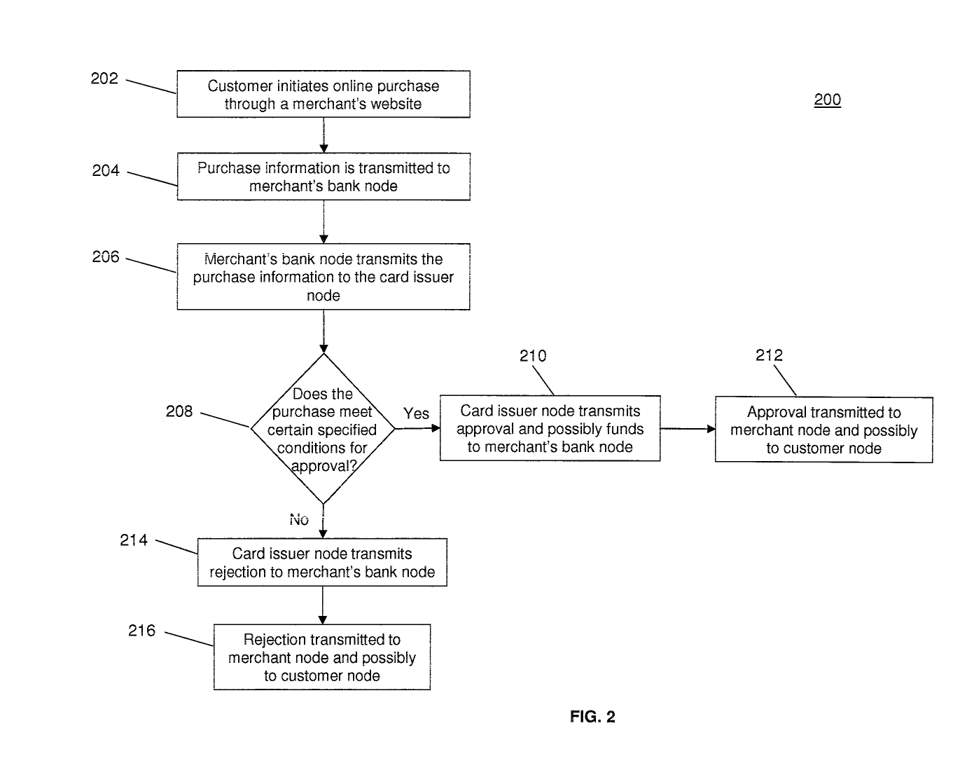

FIG. 1 shows a simplified block diagram of one implementation of a conventional online credit card system 100. System 100 may be used to perform an online transaction in real time, in which case a transaction is processed in a few seconds, or it may be used to perform transactions that are further delayed in time. System 100 includes a customer node 102, a merchant node 104, a merchant's bank node 106, a customer's credit card issuer node 108, and possibly, other intermediary party nodes (not shown). To further understand how a transaction is processed using system 100, consider the flow diagram of FIG. 2.

FIG. 2 is a simplified flow diagram illustrating the steps of a transaction 200 performed using online credit card system 100 of FIG. 1. A transaction begins at step 202 when a purchase is initiated at customer node 102 using a communications device 110, such as a computer, cell phone, PDA, or other suitable communications device for accessing the internet. The customer selects the item or items for purchase on the merchant's website, which is implemented at merchant node 104.

Merchant node 104 may be implemented using a communications device, such as a computer or server, comprising (i) a processor or controller, (ii) computer readable storage media, such as hard drives, RAM, CD-ROMs, or any other tangible medium, (iii) a transmitter, and (iv) a receiver. The computer readable storage supports the merchant's website, which may be embodied in program code. Note that, the communications device may be owned by the merchant or may be owned by a third-party service provider that supports the merchant's website for the merchant.

The merchant has a number of options for arranging its website to receive payments. For example, according to one option, the merchant's website could direct the customer to a payment webpage, such as a “shopping cart” or an online form. Merchant node 104 may then transmit the purchase information, including the cost of the purchase and the customer's personal information such as the customer's name, credit card number, and billing address, to bank node 106 (step 204). The purchase information is transmitted to bank node 106 via a payment gateway that is implemented either at bank node 106 or at a third-party node (e.g., authorize.net). According to another option, the merchant's website redirects customers to an independent payment website (e.g., paypal.com) stored on a third-party node, which may process the transaction. According to yet another option, the merchant may receive the purchase information though its website, and the merchant may process the credit card manually by entering the card number into a credit card terminal or into an online virtual terminal that transmits the purchase information to bank node 106.

Bank node 106 may be implemented using a communications device, such as a computer or server, which comprises elements similar to those of the communications device of merchant node 104. The computer readable storage of bank node 106 may support bank software for processing purchase information. The bank software may, for example, determine the credit card issuer corresponding to the credit card number, and generate an output signal based on the purchase information.

At step 206, bank node 106 transmits the purchase information to card issuer node 108. Card issuer node 108 may also be implemented using a communications device, such as a computer or server, which comprises elements similar to those of the communications device of merchant node 104. The computer readable storage of card issuer node 108 may support card issuer software for processing purchase information. The card issuer software may approve or reject the transaction by determining if the purchase meets certain specified conditions (step 208). These specified conditions may require, for example, that the customer's account has sufficient credit, that the card has not been reported missing, or that the personal information or pin number provided is correct. If the transaction is approved, then the approval is transmitted to bank node 106 (step 210), possibly with the funds required to complete the transaction. Bank node 106 transmits the approval to merchant node 104, and merchant node 104 may possibly transmit approval to customer node 102 through an email, online during the transaction, or via some other means (step 212).

If the transaction is rejected (step 208), then the rejection is transmitted to bank node 106 (step 214), bank node 106 transmits the rejection to merchant node 104, and merchant node 104 possibly transmits the rejection to customer node 102 using one of the methods described above (step 216). Note that, when using a payment gateway, the approval or rejection may be received by merchant node 104 in just a few seconds (i.e., real-time processing). Alternatively, if the merchant delays entry of the transaction into a credit card terminal or into an online virtual terminal, then the approval or rejection will be delayed by a period corresponding to the delay of the merchant.

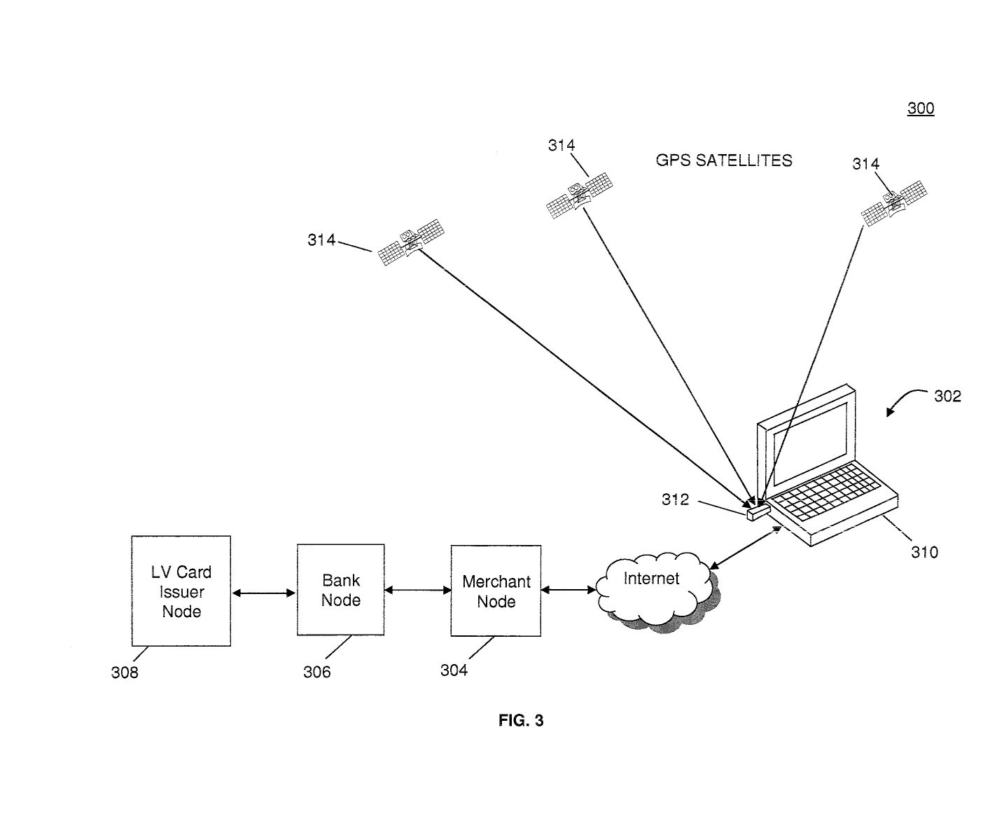

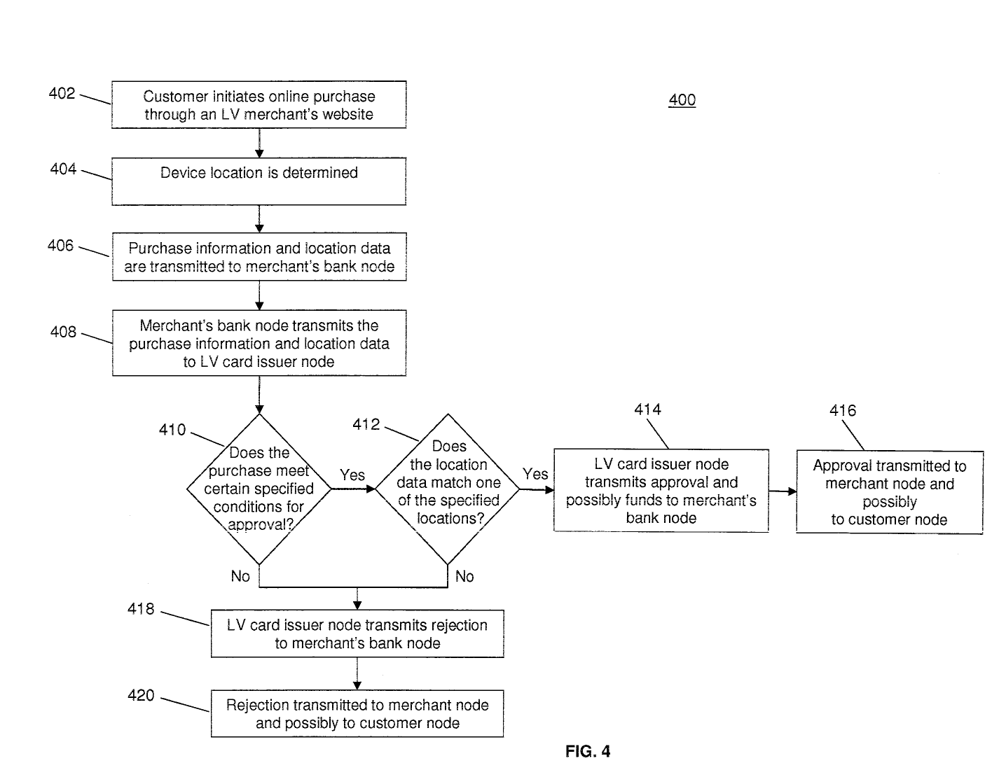

FIG. 3 shows a simplified block diagram of a location verification (LV) credit card system 300 according to one embodiment of the present invention. System 300 is a completely integrated LV credit card system in which each node in a transaction is capable of processing information about the customer's location. Similar to system 100 of FIG. 1, the nodes in a transaction of the LV credit card system 300 may include a customer node 302, a merchant node 304, a merchant's bank node 306, a customer's credit card issuer node 308 (in this case, an LV credit card issuer node), and possibly, other intermediary party nodes (not shown). Each transaction may be processed in real time or processing may be delayed by the merchant for various reasons such as to accommodate delayed payment plans. To further understand how a transaction is processed using system 300, consider the flow diagram of FIG. 4.

FIG. 4 is a simplified flow diagram illustrating the steps of a transaction 400 performed using the LV credit card system 300 of FIG. 3 according to one embodiment of the present invention. Transaction 400 is initiated (step 402) online through the merchant's website implemented on merchant node 304 in a manner similar to that of transaction 200 using a communications device 310, which may be similar to communications device 110 of FIG. 1. The merchant's website may be arranged to receive payments using any of a number of options described above in relation to merchant node 104 of system 100.

In connection with the customer selecting the item or items for purchase and inputting a credit card number and personal information, the location of communications device 310 is determined (step 404) using a GPS receiver 312. GPS receiver 312 is capable of calculating the location of device 310 based on the communication device's position relative to a number of GPS satellites 314. Receiver 312 may be (i) incorporated into communications device 310, (ii) contained in a separable piece of hardware such as a dongle device, router, or other hardware that attaches to communications device 310, or (iii) contained in a separable piece of hardware having wireless technology such as Bluetooth that is capable of communicating with communications device 310.

Triggering GPS receiver 312 to determine location data may be performed using any of a number of possible approaches. For example, according to various approaches, the location can be calculated and transmitted automatically when the customer accepts the transaction. According to other approaches, the customer may be prompted by user software or by the merchant's website to generate the location data prior to submitting the transaction. Note that, once the location data is calculated, the customer may manually enter this data onto the merchant's website. However, to prevent others from stealing the location data and from fraudulently using this data, it is preferable that the location data is independently generated without manual input by the customer on the merchant's website. In this case, if the credit card number is used fraudulently, the fraudulent user's communications device might generate location data different from that of the customer or it might not generate location data at all.

Merchant node 304 may be implemented using a communications device, such as a computer or server, which comprises elements similar to those of the merchant node 104 of FIG. 1. The computer readable storage supports both the merchant's website, which may be embodied in program code, and merchant software for processing purchase information and location data. The merchant software may generate an output signal based on (1) the location data and (2) the purchase information without considering the content of this information. Alternatively, the software may consider the information's content before generating the output signal, for example, to ensure that the customer's credit card number has been included or that the provided card number has the correct number of digits.

The purchase information and the location data are transmitted to bank node 306 (step 406), which transmits this information to LV card issuer node 308 (step 408). Bank node 306 may be implemented using a communications device, such as a computer or server, which comprises elements similar to those of merchant node 104 of FIG. 1. The computer-readable storage of bank node 306 may support bank software that processes both purchase information and location data. Similar to merchant node 104, the bank software may, for example, identify the credit card issuer corresponding to the credit card number, and generate an output signal based on both the purchase information and the location data.

LV card issuer node 308 determines if the purchase meets certain specified conditions (step 410) in a manner similar to that of step 208 of FIG. 2. Further, LV card issuer node 308 compares the location data received from bank node 306 to a predetermined list of approved purchase locations that is, e.g., provided by the customer (step 412). The approved purchase locations may include the customer's home, place of business, or other locations from which the customer anticipates making online purchases.

Depending on the particular implementation, the approved purchase locations may range from a specific point in space, such as the fixed location of a particular computer, to a broad area, such as town or city. As the range decreases, convenience to the customer is decreased because the area in which a customer may make purchases is decreased. However, as the range increases, the opportunity for the card number to be used fraudulently increases. Thus, in determining the particular ranges for approved purchase locations, convenience to the customer should be weighed against the risks of fraudulent uses.

LV card issuer node 308 may also be implemented using a communications device, such as a computer or server, which comprises elements similar to those of merchant node 104 of FIG. 1. The computer readable storage of LV card issuer node 308 may support LV card issuer software for processing both purchase information and location data. The LV card issuer software may, for example, compare the credit card number and personal information provided by the customer to the customer's account information, compare the location data to the list of approved locations provided by the customer as described above, and generate output approval or rejection signals based on these comparisons.

If the purchase information and the location is verified, then an approval is transmitted to bank node 306, possibly with the funds for the transaction (step 414). Merchant node 304 and customer node 302 may then be notified of the approval (step 416) using any of a number of approaches as discussed above in relation to step 212 of FIG. 2. If however, the purchase information is not verified, the location data does not match one of the predetermined locations, or no location data has been provided, then a rejection notice is transmitted to bank node 306 (step 418), to merchant node 304 (step 420), and possibly to customer node 302 in manners similar to those of steps 214 and 216 of FIG. 2. Alternatively, bank node 306, LV card issuer node 308, or a third-party node may notify customer node 302 of the approval or rejection.

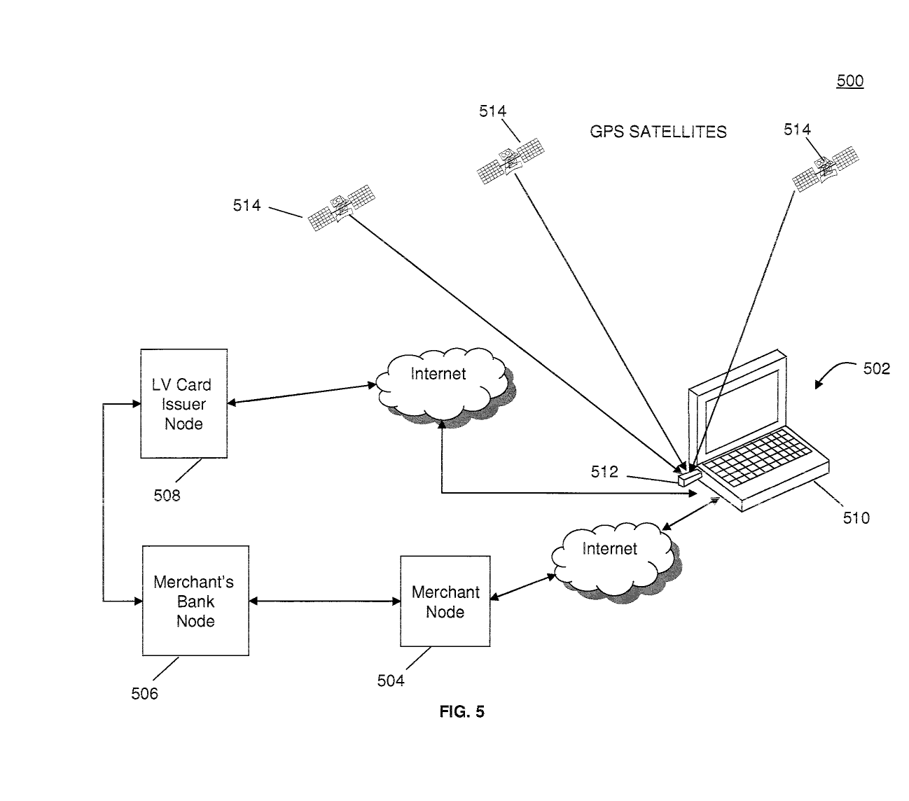

To successfully implement fully integrated LV credit card system 300 of FIG. 3, all nodes in a transaction (e.g., 400) must be capable of processing location data. In implementing a system such as that of FIG. 3, some merchants, merchants' banks, or independent third parties (such as those that manage payment gateways), might not expend the time, money, or effort to incorporate the hardware, software, or programming necessary to process location data. As a result, it is desirable that alternative LV credit card system configurations be devised to support instances in which all nodes in a transaction are not capable of processing location data. As an example, consider the alternative embodiment of FIG. 5.

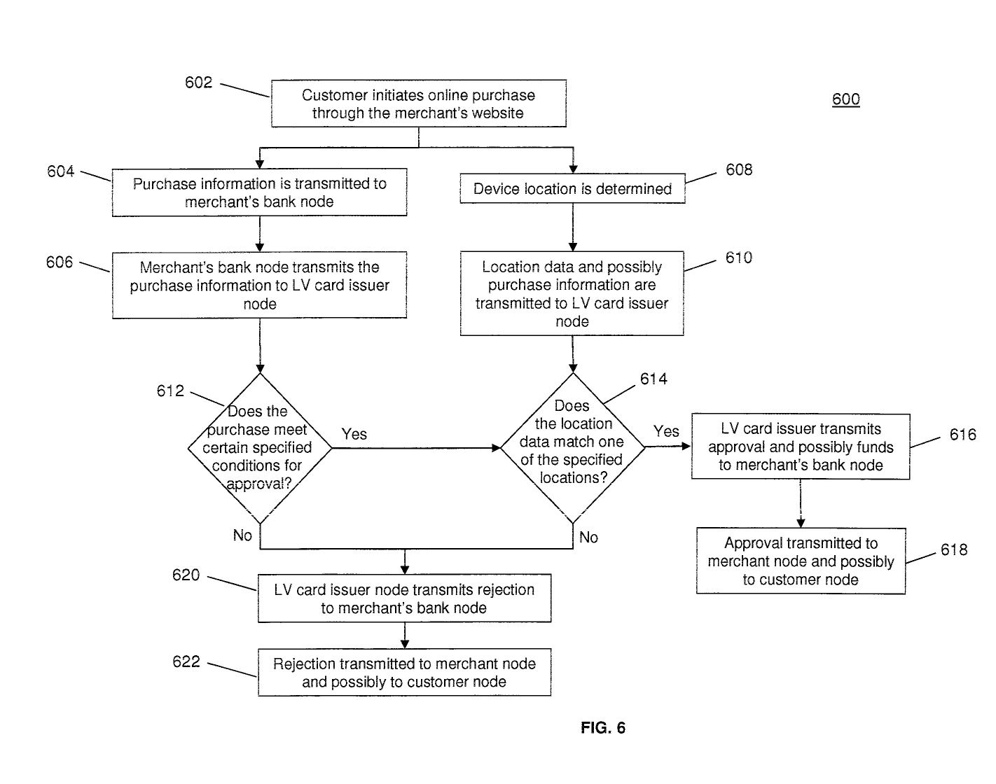

FIG. 5 shows a simplified block diagram of a location verification (LV) credit card system 500 according to another embodiment of the present invention. System 500 is a partially integrated LV credit card system in which some, but not all, nodes in a transaction are capable of processing information about the customer's location. The nodes in a transaction may be similar to those of systems 300 of FIG. 3 and 100 of FIG. 1. In this particular embodiment, merchant node 504 and merchant's bank node 506 are incapable of processing information about the customer's location, while customer node 302 and LV card issuer node 508 are capable of processing this information. In other embodiments, merchant node 504 or bank 506 might also be able to process the customer's location to LV card issuer node 508. To further understand how a transaction is processed using system 500, consider the flow diagram of FIG. 6.

FIG. 6 is a simplified flow diagram illustrating the steps of a transaction 600 performed using LV credit card system 500 of FIG. 5 according to one embodiment of the present invention. Transaction 600 may be initiated (step 602) online through the merchant's website implemented on merchant node 504 in a manner similar to that of transaction 400 using a communications device 510, which may be similar to communications device 310 of FIG. 3. The merchant's website may be arranged to receive payments using any of a number of options described above in relation to merchant node 104 of FIG. 1. According to this embodiment, merchant node 504 may be implemented as described above in relation to merchant node 104 (i.e., without software or program code for processing location data).

After the customer selects the item or items for purchase and inputs a credit card number and personal information, the purchase information is transmitted to bank node 506 (step 604), which transmits the purchase information to the LV card issuer node 508 (step 606). Bank node 506 may be implemented as described above in relation to bank node 106 of FIG. 1 (i.e., without software or program code for processing location data), and LV card issuer node 508 may be implemented as described above in relation to LV card issuer node 308 of FIG. 3 (i.e., with software or program code for processing location data).

In parallel with the processing of the purchase information, the location of communications device 510 is determined (step 608) using a GPS receiver 512, which may be similar to GPS receiver 312 of FIG. 3. The location data, and possibly the purchase information, are transmitted by customer node 302 directly to LV card issuer node 508 (step 610). Note that, as discussed above in relation to FIG. 3, if the credit card number is used fraudulently, the fraudulent user's communications device might generate location data different from that of the customer or it might not generate location data at all.

LV card issuer node 508 processes the purchase information received from bank node 506 by determining if the purchase meets certain specified conditions (step 612) in a manner similar to that of step 208 of FIG. 2. Further, LV card issuer node 508 compares the location data, if received from the customer, to the predetermined list of approved locations specified by the customer (decision 614) and possibly compares the purchase information received from the customer to that received from bank node 506. If the purchase information and the location are both verified, then steps 616 and 618 are performed in manners similar to those of steps 414 and 416 of FIG. 4, respectively. If either the purchase information or the location is not verified, then steps 620 and 622 are performed in manners similar to those of steps 418 and 420 of FIG. 4, respectively.

Triggering communications device 510 to transmit location data to LV card issuer node 508 may be performed using any of a number of different approaches. For example, according to one such approach, the LV card issuer may provide each LV card holder (i.e., the customer) with software that is capable of determining when to generate and transmit location data. These decisions could be based on, for example, identifying when the customer is typing in a credit card number. According to another such approach, the location data may be transmitted to LV card issuer node 508 through the LV card issuer's website implemented on LV card issuer node 508. For example, the LV card issuer could establish a website with multiple frames, where at least one frame may be used for searching the internet to make a purchase and another frame may be used for providing location data and possibly purchase information to LV card issuer node 508. In this case, purchases would be made by browsing merchants' websites through the LV card issuer's website.

Since merchant node 504 and bank node 506 do not process location data, the merchant and the merchant's bank are not required to implement hardware, software, or programming capable of processing this data. This embodiment provides backwards compatibility with legacy merchant and bank nodes that are unaware of the transmission of location data. Further, this embodiment may be advantageous in situations, for example, when the merchant receives credit card numbers via its website and enters the numbers into a credit card terminal to process purchases. Note that, if the merchant delays in entering a credit card purchase, LV card issuer node 508 may have to store the location data, and possibly the purchase information, provided by customer node 302 until purchase information from the merchant node 504 is available.

According to alternative embodiments of the present invention, the generation and transmission of location data may be triggered by action on the part of merchant node 304 of FIG. 3 or LV card issuer node 508 of FIG. 5. For example, either of these two nodes may ping the communications device based on the device's IP address. Software on the communications device may accept the request, generate location data, and transmit the data to the requesting node. Thus, if a fraudulent user is attempting to make a purchase from a location other than one of the predetermined locations specified by the customer, then either no location data or incorrect location data would be returned. As another example, a pop-up message from the merchant's website stored on the merchant node or the LV card issuer's website stored on the LV card issuer node may instruct the customer to accept or deny the purchase, in response to which, location data might or might not be generated. As yet another example, the merchant node or LV card issuer node may transmit an email with a weblink that the customer uses to accept or reject a purchase. If the customer accepts the purchase, then generation and transmission of location data is triggered.

According to further embodiments of the present invention, the GPS device may be implemented in a separate LV card device having wireless technology such as Bluetooth that is capable of communicating location data to the customer's communication device (e.g., 310, 510). The LV card may have the approximate dimensions of a credit card and the LV card device may also serve as a credit card for swiped transactions at a merchant's place of business.

According to yet further embodiments, the GPS device, such as the dongle device discussed above, may have provisions for swiping the credit card or debit card so that the card information is independently generated without manual input by the customer.

According to even yet further embodiments, the present invention could be implemented using any suitable encryption/decryption method such as public-key encryption/decryption. For example, the location data, and possibly the purchase information, could be encrypted by the customer node with a public key that cannot be decrypted by anyone except a recipient possessing the corresponding private key (e.g., the LV card issuer node, merchant's bank node, third-party node). Other embodiments may be implemented using pretty good privacy (PGP) and public-key infrastructure (PKI) techniques.

While the present invention was described in terms of generating a location of a communications device using GPS satellites, the present invention is not so limited. Location of the communications device may also be generated using devices other than GPS devices that are capable of calculating location data based on multilateration or triangulation techniques, such as those used in cellular phone applications. Similar to GPS devices, these other devices may be separable pieces of hardware or may be incorporated into the communications device itself.

By verifying the location from which an online purchase is made, the opportunities for fraudulent users to use stolen credit card numbers may be reduced over other methods that require manual input of a pin number or other personal information. The location data, which is specific to the particular LV card holder, may be transmitted automatically (without manual input), thereby reducing the opportunities for a fraudulent user to use this information to make online purchases.

While the present invention was described relative to its use with credit card accounts or debit card accounts, the present invention is not so limited. The present invention may also be used with accounts other than credit card accounts or debit card accounts in which a card has not been issued, such as a bank account or other types of credit accounts.

Further, various arrangements of parties, other than those described above, may be envisioned within the scope of this invention. For example, according to alternative embodiments, the bank node may be the same as the LV card issuer node or other intermediary nodes may be included in a purchase. As another example, the merchant node could transmit purchase information and possibly location data, directly to the card issuer node without transmitting this information to the bank node. Further, nodes other than the LV card issuer node could be used to verify the location data. For example, a third party node that implements a payment gateway could comprise a location verification device, possibly similar to one that would be used by the LV card issuer node, wherein the location verification device is used to verify the location data.

Certain aspects of the present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Certain aspects of the present invention can be embodied in the form of methods and apparatuses for practicing those methods. Certain aspects of the present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. Certain aspects of the present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. Certain aspects of the present invention can also be embodied in the form of a bitstream or other sequence of signal values electrically or optically transmitted through a medium, stored magnetic-field variations in a magnetic recording medium, etc., generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

We claim:

1. A computer-implemented method for processing an internet-based purchase request made by a user of a communications device, the method comprising:
(a) receiving, from the communications device, the purchase request and location information corresponding to location of the communications device, wherein:
the purchase request includes information about a customer account; and
the location information is independently generated by the communications device;
(b) comparing the location information to one or more approved locations corresponding to the customer account; and
(c) if the location information does not match any of the one or more approved locations, then rejecting the purchase request.

2. The invention of claim 1, further comprising:
(d) determining whether one or more other specified conditions relating to the purchase request are satisfied, wherein the purchase request is granted, if (i) the location information matches one of the one or more approved locations and (ii) if the one or more other specified conditions relating to the purchase request are satisfied.

3. The invention of claim 1, wherein the location information is generated by a global positioning system (GPS) receiver associated with the communications device.

4. The invention of claim 1, wherein the location information is generated using cellular phone location technology associated with the communications device.

5. The invention of claim 1, wherein the customer account is a credit card or debit card account issued by a card account company that implements the method.

6. The invention of claim 5, wherein the purchase request is received by a card account company device from the communications device via a merchant device.

7. The invention of claim 6, wherein the location information is received by the card account company device from the communications device via the merchant device.

8. The invention of claim 6, wherein the location information is received by the card account company device from the communications device independent of the merchant device.

9. The invention of claim 1, wherein the location information is encrypted and step (a) further comprises decrypting the encrypted location information.

10. A computer device for processing an internet-based purchase request made by a user of a communications device, the computer device comprising:
a means for receiving, from the communications device, the purchase request and location information corresponding to location of the communications device, wherein:
the purchase request includes information about a customer account; and
the location information is independently generated by the communications device;
a means for comparing the location information to one or more approved locations corresponding to the customer account; and
a means for rejecting the purchase request if the location information does not match any of the one or more approved locations.

11. A computer-implemented method for making an internet-based purchase request from a user of a communications device, the method comprising:
(a) transmitting the purchase request to a merchant device via the internet, wherein:
the purchase request includes information about a customer account issued by a customer account company; and
the merchant device transmits the customer account information to a customer account company device;
(b) independently generating location information corresponding to location of the communications device; and
(c) transmitting the location information to a location verification device, wherein the location verification device (i) compares the location information to one or more approved locations corresponding to the customer account and (ii) rejects the purchase request, if the location information does not match any of the one or more approved locations.

12. The method of claim 11, wherein:
step (b) further comprises encrypting the location information corresponding to the location of the communications device; and
the customer account company device decrypts the location information.

13. A communications device for making an internet-based purchase request from a user of the communications device, the communications device adapted to:
(a) transmit the purchase request to a merchant device via the internet, wherein:
the purchase request includes information about a customer account issued by a customer account company; and
the merchant device transmits the customer account information to a customer account company device;
(b) independently generate location information corresponding to location of the communications device; and
(c) transmit the location information to the customer account company device, wherein the customer account company device (i) compares the location information to one or more approved locations corresponding to the customer account and (ii) rejects the purchase request, if the location information does not match any of the one or more approved locations.

14. The invention of claim 13, wherein the communications device comprises a GPS receiver adapted to independently generate the location information.

15. The invention of claim 13, wherein the communications device comprises cellular phone location hardware adapted to independently generate the location information.
